(19) United States
(12) Patent Application Publication
(10) Pub. No.: US 2016/0307309 A1
(43) Pub. Date: Oct. 20, 2016

(54) Cosmetic Evaluation Box for Used Electronics

(71) Applicants: Tu Nguyen, Fremont, CA (US); Tien Trinh, Ho Chi Minh City (VN)

(72) Inventors: Tu Nguyen, Fremont, CA (US); Tien Trinh, Ho Chi Minh City (VN)

(73) Assignee: GDT, INC., Fremont, CA (US)

(21) Appl. No.: 14/690,451

(22) Filed: Apr. 19, 2015

(51) Int. Cl. G06T 7/00; H04N 5/225; G01N 21/95

(52) U.S. Cl. CPC G06T 7/0004; G01N 21/95; H04N 5/2256; H04N 5/2252; G01N 2201/061; G01N 2201/022

(57) ABSTRACT

A cosmetic evaluation system for electronic devices, using at least two cameras to evaluate the cosmetic condition of an electronic device.

### CROSS-REFERENCE TO RELATED APPLICATIONS

The present application takes priority from Provisional App. No. 61/984,666, filed Apr. 24, 2014, which is herein incorporated by reference.

### BACKGROUND

Smartphones and other small electronic devices evolve rapidly, and thus are frequently upgraded by consumers. As a result, many consumers have one or more used electronic devices that they no longer need. Reselling those devices is often a hassle that does not justify the time or the expense of doing so.

In order to determine the value of a used electronic device, its functional capacity and its cosmetic condition need to be evaluated. While it is fairly easy to test the function of an electronic device objectively, an evaluation of a device's cosmetic condition is often subjective and prone to human bias. While electronic kiosks often do possess camera systems that enable them to take images of an electronic device in order to repurchase it from a consumer, it may also be desirable to evaluate the cosmetic condition of an electronic device on the factory floor, in a retail setting, or at any other location where a kiosk may be too unwieldy and the other functions of a repurchasing kiosk are not required.

A need exists for a freestanding, dedicated machine for the cosmetic evaluation of an electronic device.

For purposes of the present disclosure, an “electronic device” is a smartphone, cell phone, tablet, media player, gaming device, camera, medical device, or any other portable electronic device that may need a cosmetic evaluation.

### SUMMARY OF THE INVENTION

The present invention is a cosmetic testing fixture for an electronic device. In the preferred embodiment, the cosmetic testing fixture comprises an enclosure with a user interface, and a device holder within the enclosure. The device holder is a clip capable of holding the electronic device without obstructing its front or back surface. In an embodiment, several sizes of device holders may be installed, or the device holder may be removable and replaceable.

The cosmetic testing fixture also comprises at least one camera, said camera positioned in such a way as to be able to take a photograph of the front surface of the electronic device when it is in the device holder. In an embodiment, the cosmetic testing fixture also comprises a second camera that is positioned in such a way as to be able to take a photograph of the back surface of the electronic device when it is in the device holder.

The processor may be configured to analyze the photograph or photographs to evaluate the cosmetic condition of the electronic device. In another embodiment, the processor may be configured to transmit the photograph or photographs to a server. In either of these embodiments, the processor may also be configured to steganographically encode information in the photograph or photographs. Such information may include the device ID, manufacturer, model, operating system type, owner name, date/time stamp, and anti-tampering information (for example, the number of blue pixels in the photograph).

The cosmetic testing fixture also comprises at least one light fixture, said light fixture located within the enclosure in such a way as to provide adequate lighting for the camera or cameras to take a photograph of the electronic device. In an embodiment, the inside of the enclosure comprises a matte light-colored surface to maximize illumination and minimize unwanted reflections.

The cosmetic testing fixture preferably comprises doors that can close in a way that prevents any external light from coming into the fixture. In an embodiment, the doors close automatically when the test starts and open automatically when the test is over.

The method of the present invention comprises placing an electronic device in a cosmetic testing fixture, said fixture comprising a device holder, at least one camera, at least one light fixture, and a processor; using the processor to identify the electronic device; taking at least one photograph of the electronic device using at least one camera; steganographically encoding information about the electronic device in the at least one photograph; and analyzing the photograph to determine the cosmetic condition of the electronic device. The analyzing step can be performed by the processor, or the photograph can be transmitted to a server for this analysis.

### LIST OF FIGURES

FIG. 1 shows the structure of the system of the present invention.

FIG. 2 shows the outside of the enclosure of the present invention.

### DETAILED DESCRIPTION OF THE PREFERRED EMBODIMENT

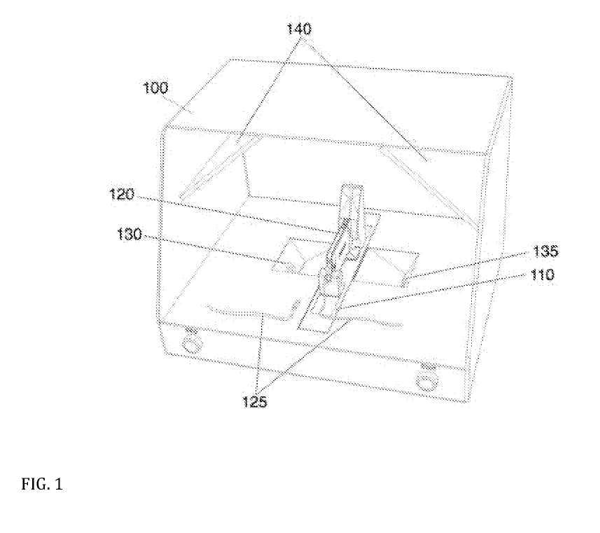

FIG. 1 shows a view of the preferred embodiment of the present invention. It is preferably an enclosure 100 with a holder module 110 located approximately at the midpoint of the container. Holder module 110 is preferably sized and shaped in such a way as to hold a smartphone or other small electronic device 120 without obstructing the electronic device's front or back. In an embodiment, different-size holder modules may be used depending on what electronic device is tested; the enclosure 100 may have mounting hardware that allows different holder modules to be attached.

Cable 125 is used to connect to the electronic device 120. In the preferred embodiment, several different cables are provided, each cable comprising a different connector for a different electronic device. The cable 125 connects the electronic device 120 to a processor and memory (not shown), which is then used to identify the device and, in an embodiment, control the device during the evaluation process.

Front camera 130 and back camera 135 are then used to take images of the electronic device. The front camera and back camera are preferably standard digital cameras that offer sufficient resolution to be able to register typical imperfections and wear marks on a typical electronic device. The front camera and back camera are controlled by the processor.

Light panels 140 are used to illuminate the inside of the enclosure so that the cameras can take good images. In the preferred embodiment, standard white light panels are used for this purpose.

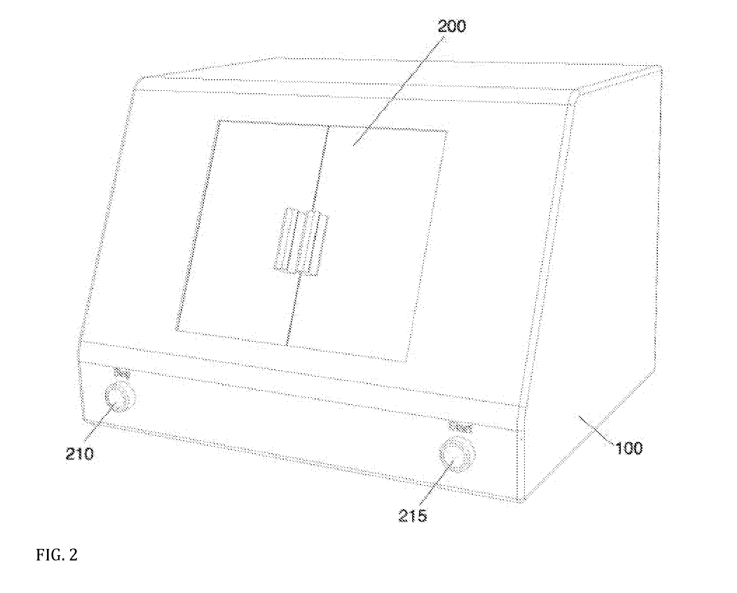

As shown in FIG. 2, the enclosure preferably comprises sliding doors 200 to prevent extraneous light from coming in. In the preferred embodiment, the sliding doors snap closed to prevent their accidental opening during the evaluation process. Hinged doors or other types of doors may also be used. The start button 210 enables the user to start the evaluation process. The stop button 215 enables the user to stop the evaluation process before it is fully completed. In an embodiment, the start button 210 locks the sliding doors 200, and the stop button 215 unlocks them; they also unlock automatically at the end of the evaluation process.

In the preferred embodiment, once the photos are taken, the processor encodes information in them steganographically. This information may include device ID number, manufacturer, model, owner name, date and time of the evaluation, anti-tampering information such as the number of blue pixels in the photo, and any other information regarding the electronic device.

In the preferred embodiment, once the photos are taken and encoded with the information, they are transmitted via a wired or wireless connection to a server. The photos are then analyzed to determine the number of scratches, wear marks, cracks, and other imperfections on the electronic device. The electronic device is then rated based on the number, type, and length of these imperfections.

In an alternate embodiment, the photos are analyzed by the processor. The processor preferably performs the following functions: modifies at least one parameter of the photo or photos to make cosmetic imperfections more apparent, determines the number, length, and type of the imperfections, and uses this information to grade the electronic device's cosmetic condition. In the preferred embodiment, three possible grades are used—“Like New” (for devices that have no or minimal cosmetic imperfections), “Broken” (for devices that have cracks anywhere on the screen or the back), and “Used” (for any devices that do not fit either of the above two categories).

The enclosure is preferably large enough to comfortably contain a tablet such as an iPad, while still being small enough to be able to be placed on a desktop or countertop. In the preferred embodiment, the inside of the enclosure is matte white to minimize reflections and maximize illumination.

Exemplary embodiments are described above. It will be understood that the invention is not limited by these exemplary embodiments, but solely by the appended claims and any reasonable equivalents thereof.

1. A cosmetic testing fixture for an electronic device, said electronic device comprising a front surface and a back surface, said cosmetic testing fixture comprising:
an enclosure;
a user interface;
a device holder, said device holder mounted inside the enclosure, said device holder capable of securely holding an electronic device without obstructing its front surface or its back surface;
a first camera, said first camera positioned in such a way as to be able to take a photograph of the front surface of the electronic device;
at least one light fixture, said light fixture located within the enclosure in such a way as to provide adequate lighting for the first camera to take a photograph of the electronic device;
a device connector, said device connector connected to the electronic device;
a processor, said processor configured to perform the following functions:
identify the electronic device;
trigger the first camera to take a first photograph.

2. The cosmetic testing fixture of claim 1, further comprising:
a second camera, said second camera positioned in such a way as to be able to take a photograph of the back surface of the electronic device;
where the processor is further configured to perform the following function:
trigger the second camera to take a second photograph.

3. The cosmetic testing fixture of claim 1, where the processor is further configured to:
analyze the first photograph to evaluate the cosmetic condition of the electronic device.

4. The cosmetic testing fixture of claim 1, where at least one inside surface of the enclosure is matte.

5. The cosmetic testing fixture of claim 1, where the enclosure comprises at least one sliding door.

6. The cosmetic testing fixture of claim 1, where the device holder is removable, further comprising:
a second device holder, said second device holder sized in a way as to hold an electronic device of a different size than the device holder, said second device holder capable of being mounted within the enclosure.

7. The cosmetic testing fixture of claim 1, where the processor is further configured to:
steganographically encode information regarding the electronic device in the first photograph, said information comprising at least one of the device ID, manufacturer, model, operating system type, owner name, date/time stamp, and anti-tampering information.

8. The cosmetic testing fixture of claim 2, where the processor is further configured to:
steganographically encode information regarding the electronic device in the second photograph, said information comprising at least one of the device ID, manufacturer, model, operating system type, owner name, date/time stamp, and anti-tampering information.

9. The cosmetic testing fixture of claim 1, further comprising:
a communication module, said communication module capable of transmitting data to a server.

10. A method of analyzing the cosmetic condition of an electronic device, comprising:
placing the electronic device in a fixture, said fixture comprising a device holder, at least one camera, at least one light fixture, and a processor;
using the processor to identify the electronic device;
taking at least one photograph of the electronic device using the at least one camera;
steganographically encoding information comprising at least one of the device type, device manufacturer, device operating system, owner name, and device ID number in the at least one photograph of the electronic device;
transmitting the at least one photograph of the electronic device to a server.

11. The method of claim 10, further comprising:
analyzing the at least one photograph of the electronic device to determine the cosmetic condition of the electronic device.
